(19) United States
(12) Patent Application Publication
(10) Pub. No.: US 2018/0258692 A1
(43) Pub. Date: Sep. 13, 2018

(54) Window Shade Device

(71) Applicant: Matthew B. Conway, Boston, MA (US)

(72) Inventor: Matthew B. Conway, Boston, MA (US)

(21) Appl. No.: 15/913,137

(22) Filed: Mar. 6, 2018

Related U.S. Application Data
(60) Provisional application No. 62/469,222, filed on Mar. 9, 2017.

(51) Int. Cl. E06B 9/38; E06B 7/18

(52) U.S. Cl. CPC E06B 9/38; E06B 9/262; E06B 7/18

(57) ABSTRACT

The present invention provides a sealing apparatus for a window shade that is vertically raised and lowered. The sealing apparatus can include a first side seal assembly having a first side air seal member that is vertically oriented. The first side seal member can be movably connected to a first side frame member by a first movable arrangement for moving the first side seal member laterally into and out of sealing position relative to a first side of the window shade.

### RELATED APPLICATION

This application claims the benefit of U.S. Provisional Application No. 62/469,222, filed on Mar. 9, 2017. The entire teachings of the above application are incorporated herein by reference.

### BACKGROUND

Vertically raised and lowered window shades can be installed on windows to save energy for heating and cooling. However, airflow around the sides of the window shade can decrease the thermal insulating efficiency of the window shade. Differences in the density of the cold air near the window glass and less dense warm air inside buildings results in convective air movement around the gaps at the sides and bottom of standard thermal shades. Specifically, the heavy, cold air builds up on the backside of shades near the glass. The density of cold air between the glass and shade, causes air to drop under and leak around the sides of standard thermal shades. Fixed, non-movable end air seals have been used to seal the edges of some prior shades, but when the seals are tight enough to form an air seal, they often cause alignment problems or binding.

### SUMMARY OF THE INVENTION

The present invention can provide a thermal window shade with a sealing apparatus that can seal the sides of the window shade, preventing or restricting airflow for improving thermal insulating efficiency, while at the same time not interfering when the window shade is lowered and raised. The present invention can also provide a sealing apparatus for a window shade that is vertically raised and lowered. The sealing apparatus can include a first side seal assembly having a first side air seal member that is vertically oriented. The first side seal member can be movably connected to a first side frame member by a first movable arrangement for moving the first side seal member into and out of sealing position relative to a first side of the window shade. The first side seal member can be moved laterally.

In particular embodiments, the first movable arrangement can include a linkage for moving the first side seal member into and out of sealing position relative to the first side of the window shade. The first side seal member can move vertically and laterally. The linkage can be biased by a spring in a non-sealing direction. A first side seal activation tab can extend laterally from a bottom of the first side seal member for being engaged by a bottom of the window shade when lowered for pulling the first side seal member downwardly and laterally against the first side of the window shade. The linkage, the first side seal member and the first side frame member can form at least one four bar linkage. The first side frame member can include a vertically oriented channel member for securing to a window frame. A vertically oriented adjustable linkage base can be secured within the channel member. The first side seal member can be movably connected to the adjustable linkage base by the linkage. At least one lateral adjustment mechanism can be included between the channel member and the adjustable linkage base for adjusting to compensate for non-square window frames. A second side seal assembly having a second side air seal member that is vertically oriented can be included. The second side seal member can be movably connected to a second side frame member by a second movable arrangement for moving the second side seal member into and out of sealing position relative to a second side of the window shade. The second side seal member can move laterally. The sealing apparatus can include the window shade, thereby forming a window shade system with movable side seals. The first and second side seal members can be normally in a non-sealing position to allow the window shade to be vertically raised and lowered without interference by the side seal members. The first and second side seal members can be activated to move by the respective movable arrangements into sealing position to seal relative to the first and second sides of the window shade when the window shade is in the lowered position. The first and second side seal members can move laterally to seal against the first and second sides of the window shade.

In some embodiments, the first movable arrangement can move the first side seal member in a lateral direction into and out of sealing position relative to a side edge of the first side of the window shade. The first movable arrangement can include an electrically or electronically controlled actuator or activator. The first movable arrangement can also include a linkage actuated by the actuator for moving the first side seal member into and out of sealing position. The actuator can include a telescoping extension arm connected to the linkage by a pivoting actuator link. The actuator can be positioned laterally relative to the first side seal member and above the window shade. The electronically controlled actuator can be controlled with at least one of sensors and switches.

The present invention can also provide a sealing apparatus for a window shade that is vertically raised and lowered, including a first side seal assembly having a first side seal member that is vertically oriented. The first side seal member can be movably connected to a first side frame member by a first movable arrangement for moving the first side seal member into and out of sealing position relative to a side edge of a first side of the window shade. A second side seal assembly can have a second side seal member that is vertically oriented. The second side seal member can be movably connected to a second side frame member by a second movable arrangement for moving second the side seal member into and out of sealing position relative to a side edge of a second side of the window shade. The first and second side seal members can move towards each other when moving into sealing position, and away from each other when moving out of sealing position.

The present invention can also provide a method of releasably sealing a window shade that is vertically raisable and lowerable, with a vertically oriented first side air seal member of a first side seal assembly. With the first side seal member being out of sealing position, the window shade can be vertically lowered downwardly until reaching a lowered position. A first movable arrangement can be activated when the window shade is near or at the lowered position to move the first side seal member into sealing position relative to a first side of the window shade for sealing therebetween. The first side seal member can be movably connected to a first side frame member by the first movable arrangement. Vertically raising the window shade can activate the first movable arrangement to move the first side seal member out of sealing position relative to the first side of the window shade so as not to interfere with the raising of the window shade. The first side seal member can move laterally.

In particular embodiments, the first movable arrangement can include a linkage for moving the first side seal member into and out of sealing position relative to the first side of the window shade. The first side seal member can move vertically and laterally. The linkage can be biased in a non-sealing direction with the spring. A first side seal activation tab can extend laterally from a bottom of the first side seal member. The tab can be engaged with a bottom of the window shade when lowered for pulling the first side seal member downwardly and laterally against the first side of the window shade. The linkage, the first side seal member and the first side frame member can form at least one four bar linkage. The first side frame member can include a vertically oriented channel member for securing to a window frame. A vertically oriented adjustable linkage base can be secured within the channel member. The first side seal member can move relative to the adjustable linkage base with the linkage that is movably connected therebetween. At least one lateral adjustment mechanism can be adjusted between the channel member and the adjustable linkage base to compensate for non-square window frames. A second side seal assembly having a second side air seal member that is vertically oriented can be included. The second side seal member can be moved into and out of sealing position relative to a second side of the window shade with a second movable arrangement. The second side seal member can move laterally. The first and second side seal members can be normally positioned in a non-sealing position to allow the window shade to be raised and lowered without interference by the side seal members. The first and second side seal members can be activated to move by the respective movable arrangements into sealing position to seal relative to the first and second sides of the window shade when the window shade is in the lowered position. The first and second side seal members can move laterally to seal against the first and second sides of the window shade.

In some embodiments, the first side seal member can move in a lateral direction into an out of sealing position relative to a side edge of the first side of the window shade. The first movable arrangement can include an electrically or electronically controlled actuator or activator. The first movable arrangement can also include a linkage actuated by the actuator for moving the first side seal member into and out of sealing position. The actuator can include a telescoping extension arm connected to the linkage by a pivoting actuator link. The actuator can be positioned laterally relative to the first side seal member and above the window shade. The electronically controlled actuator can be controlled with at least one of sensors and switches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a front perspective view of a window having an embodiment of a window shade system including a sealing apparatus with side seals in the present invention, the shade being in the retracted or partially open position as viewed from inside a building, looking out towards the window glass. FIG. 1A is a perspective view of examples of accordion profile shades, and FIG. 1B is a perspective view of a portion of a square profile shade.

FIG. 2 is a top perspective view of the right side of the window shade system with the upper window frame member removed showing the major components of the side seal that are located internal to the side channel.

FIG. 3 is a top view of FIG. 2 with the side seal in the open/retracted position.

FIG. 4 is a top view of FIG. 2 with the side seal in the closed position.

FIG. 5 is a front perspective view of a portion of the window shade system with the shade and the side seals in the closed position as viewed from inside the building, looking out towards the window glass.

FIG. 6 is a perspective sectional view of a portion of an adjustable linkage base and a side channel member with an adjustment mechanism, for window openings that are not square or openings with non-uniform dimensions, that allows the side seal to be aligned with the shade.

FIG. 7 is a side sectional view of a portion of a side window frame member, side channel member, adjustable linkage base and adjustment mechanisms, depicting adjustment to allow the adjustable linkage base to be moved to compensate for a window opening that is not square, ensuring that the side seal is aligned with the vertical ends of the shades.

FIG. 8 is a perspective view of a portion of the mechanical linkage components for moving a side seal by rotating down and towards the shade, to create a seal, when the shade is in the closed position, with a portion cut away.

FIG. 9 is a front view of a portion of the window shade system showing mechanical linkage components involved in closing the side seal where the side seal is closed via the linkage, and rotates down and inward towards the vertical ends of the shade about pivot points when the shade is closed, as the weight of the shade weighted bottom pushes down on a side channel tab.

FIG. 10 is a front view of a portion of the window shade system showing the shade being opened and the shade weighted bottom being lifted off of the side channel tab, a spring causing the mechanical linkage to rotate back, up and away from the shade to the retracted position, the moveable component and the side seal return to a location inside the side channel.

FIG. 11 is a perspective view of a portion of the window shade system with the shade being in a partially retracted position.

FIG. 12 is a perspective view of a portion of the window shade system with the shade in a closed and sealed position.

FIG. 13 is an exploded perspective view of components of embodiments of one side of the window shade system.

FIG. 14 is a perspective view of a right side of another embodiment of the window shade system in the present invention in a window, with the upper window frame member removed, having an actuator for moving the side seal.

FIG. 15 is a top view of FIG. 14 with the side seal in the retracted position.

FIG. 16 is a top view of FIG. 14 with the side seal in the closed position.

FIG. 17 is a perspective view of a portion of the window shade system of FIG. 14 with the shade being in a partially retracted position.

FIG. 18 is a perspective view of a portion of the window shade system of FIG. 14 with the shade in a closed and sealed position.

FIG. 19 is a front perspective view of a window including the window shade system of FIG. 14, with one arrangement of sensors or switches for controlling operation.

FIG. 20 is an exploded view of components for one side of FIG. 19.

FIG. 21 is a front perspective view of a window including the window shade system of FIG. 14 with another arrangement of sensors or switches.

FIG. 22 is an exploded view of components for one side of FIG. 21.

### DETAILED DESCRIPTION OF THE INVENTION

A description of example embodiments of the invention follows.

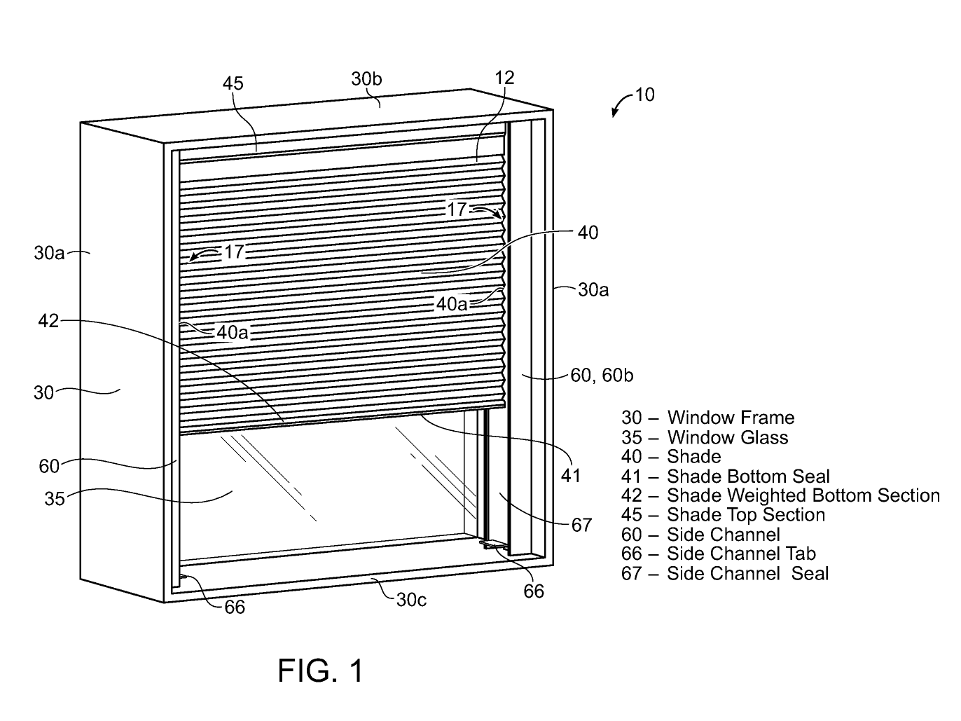

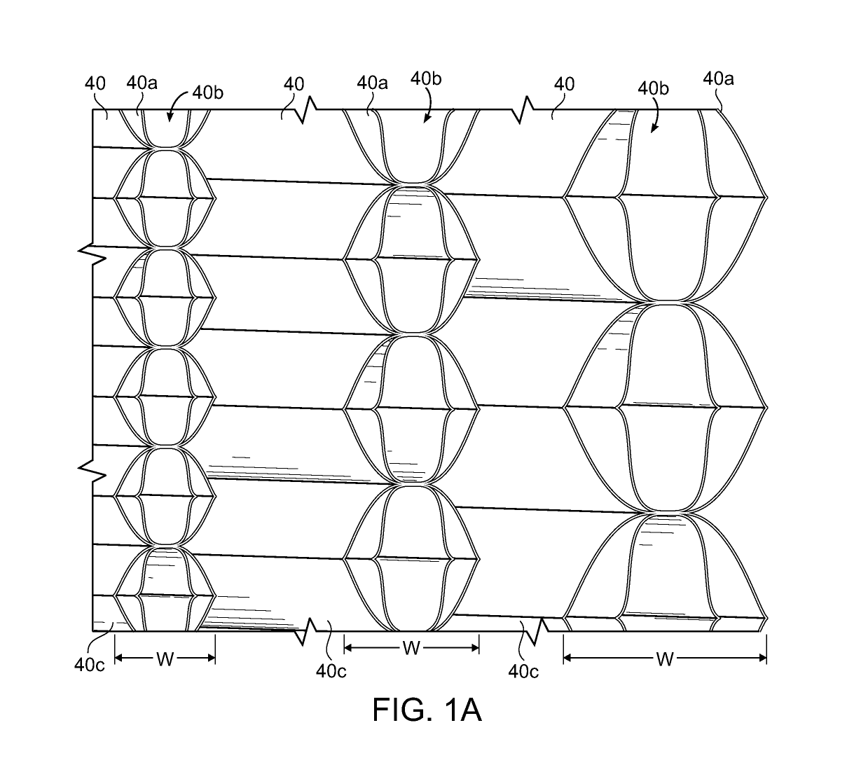

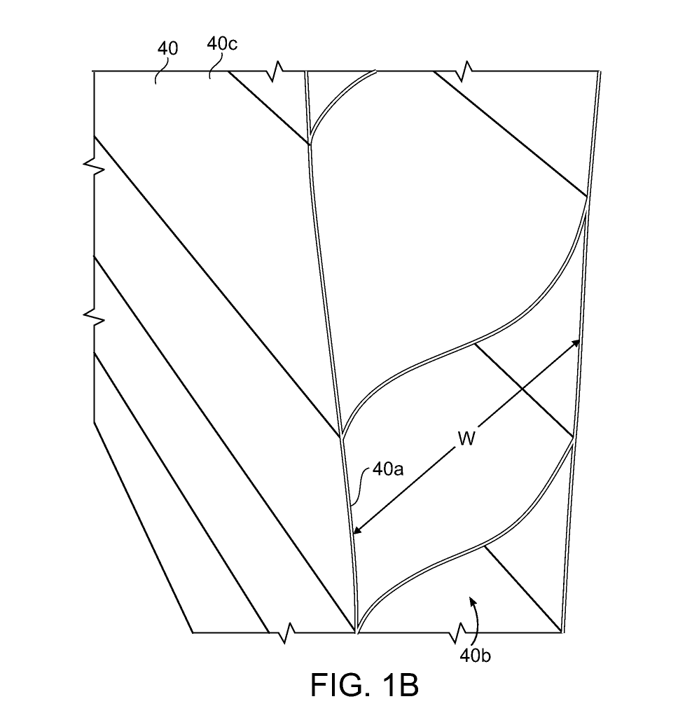

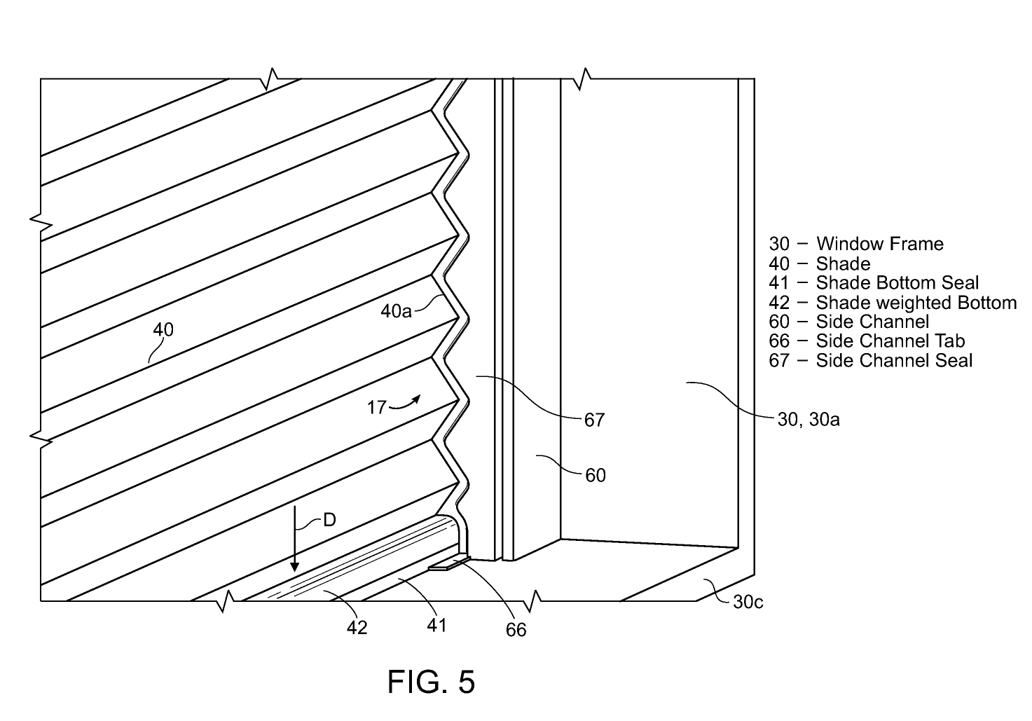

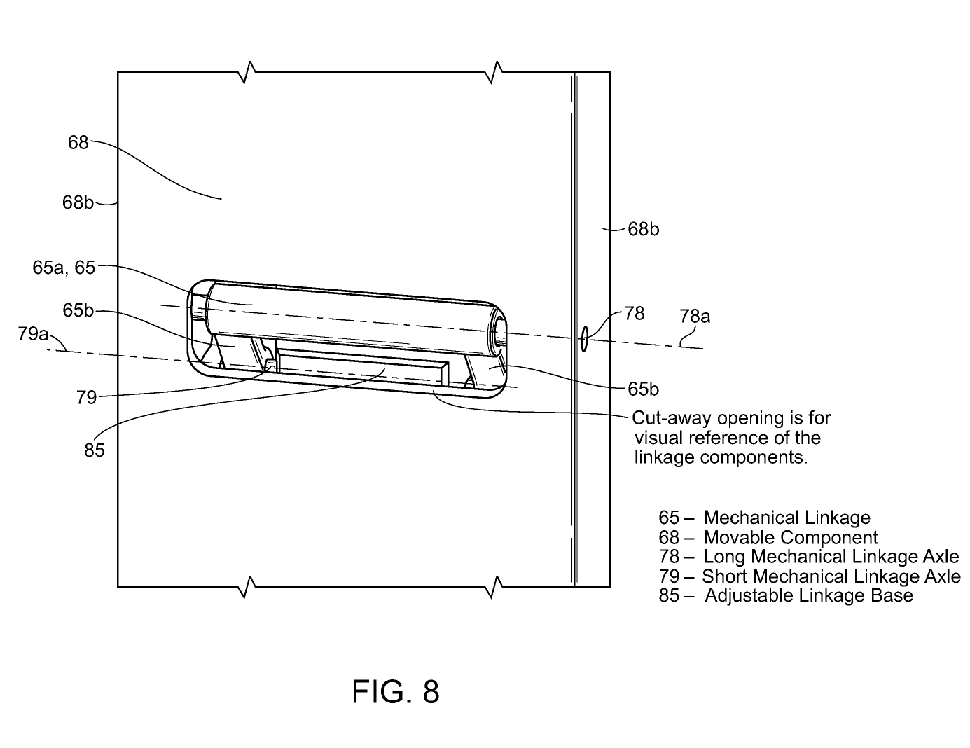

Referring to FIGS. 1-13, an embodiment of window shade system 12 in the present invention can be installed within a window 10. The window 10 can have a pane of window glass 35 mounted or supported within a window frame 30 having two side window frame members 30a, a top or upper window frame member 30b and a bottom or lower window frame member or sill 30c.

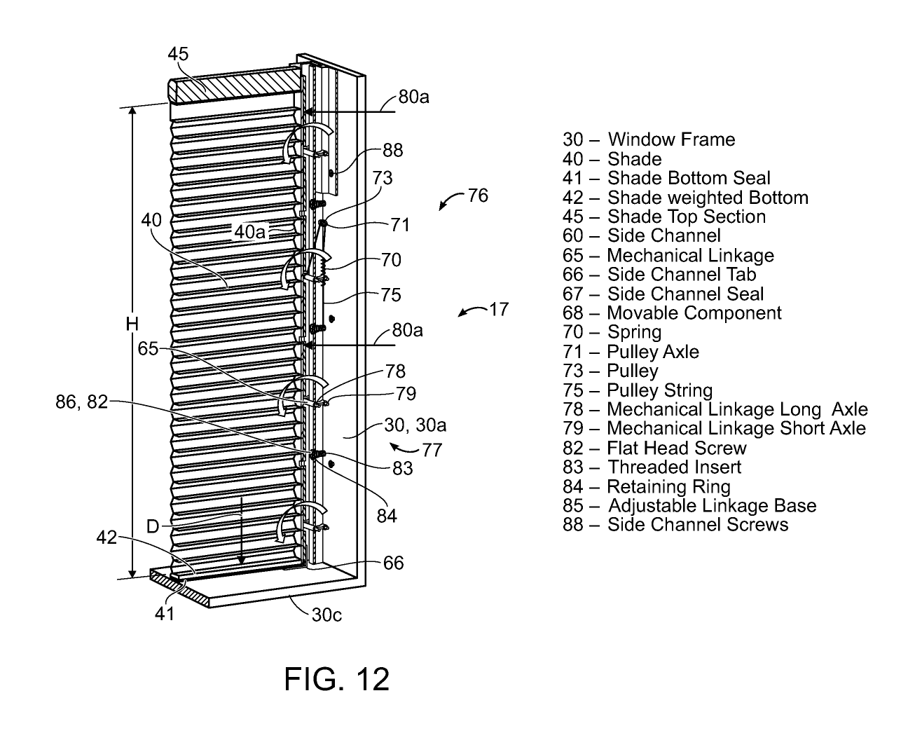

The window shade system 12 can include an upper or top shade section 45, to which an insulative thermal window shade 40 is attached, for vertically raising and lowering. The construction of the window shade 40 can include a number of different configurations or styles as desired, such as flexible sheet, pleated, quilted or accordion shades 40. FIG. 1A depicts some examples of collapsible accordion profile shades 40 formed of flexible sheet material 40c having two opposite lateral sides or edges 40a, internal insulative cavities 40b and a width W. FIG. 1B depicts an embodiment of Shade 40 having rectangular or square cavities 40b. The bottom of the shade 40 can have a weighted bottom section or portion 42 and a bottom shade seal 41, such as a gasket seal for sealing against the bottom window frame member 30c to prevent or limit airflow therebetween, when the shade 40 is in the down position. The lateral upright or vertical sides 40a of the shade 40 can be sealed by two side seal assemblies 17 providing two movable upright or vertically oriented opposing side channel seals, side seals or side seal members 67, which can seal the width W of the lateral sides 40a along the height H (FIG. 12) of the shade 40 when extended in the down position, to prevent or limit airflow around the two lateral sides 40a of the shade 40. As a result, window shade system 12 can prevent cold air in the winter, and hot air in the summer from flowing and escaping around the sides 40a and bottom seal 41 of the shade 40, thereby providing increased thermal insulating efficiency of the window shade system 12, resulting in savings in heating and cooling of a building.

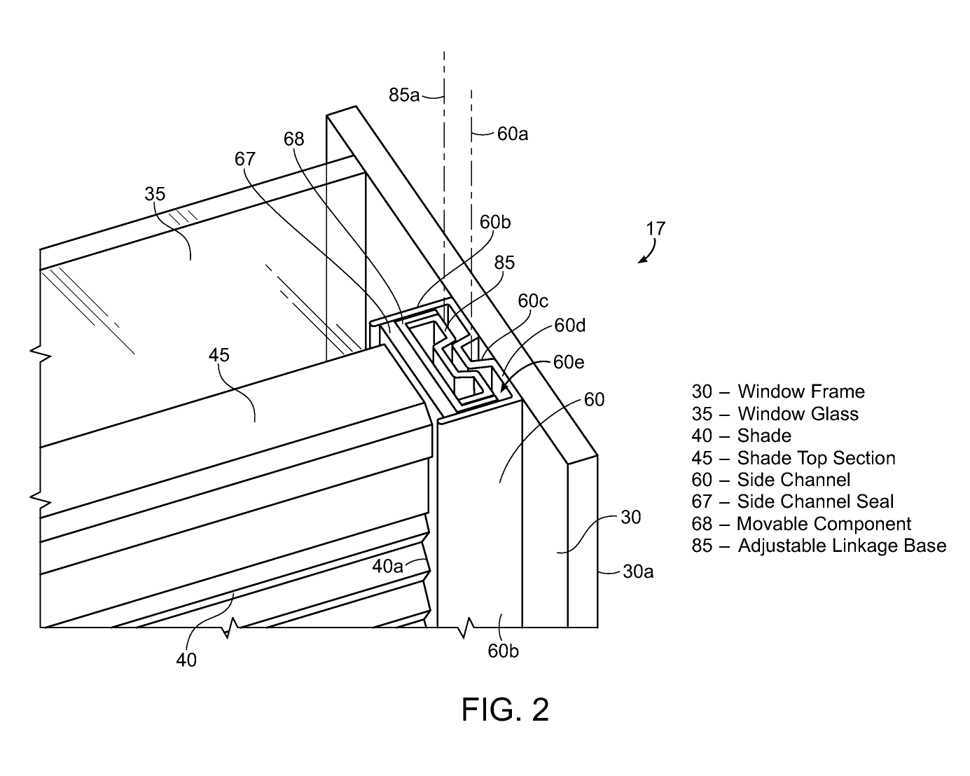

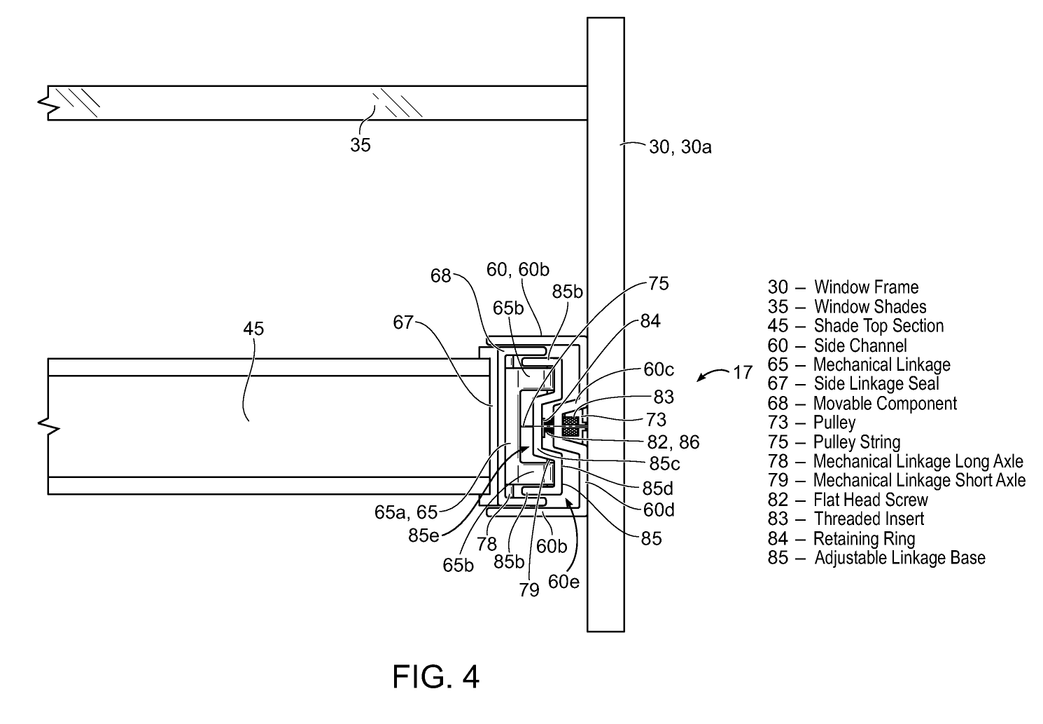

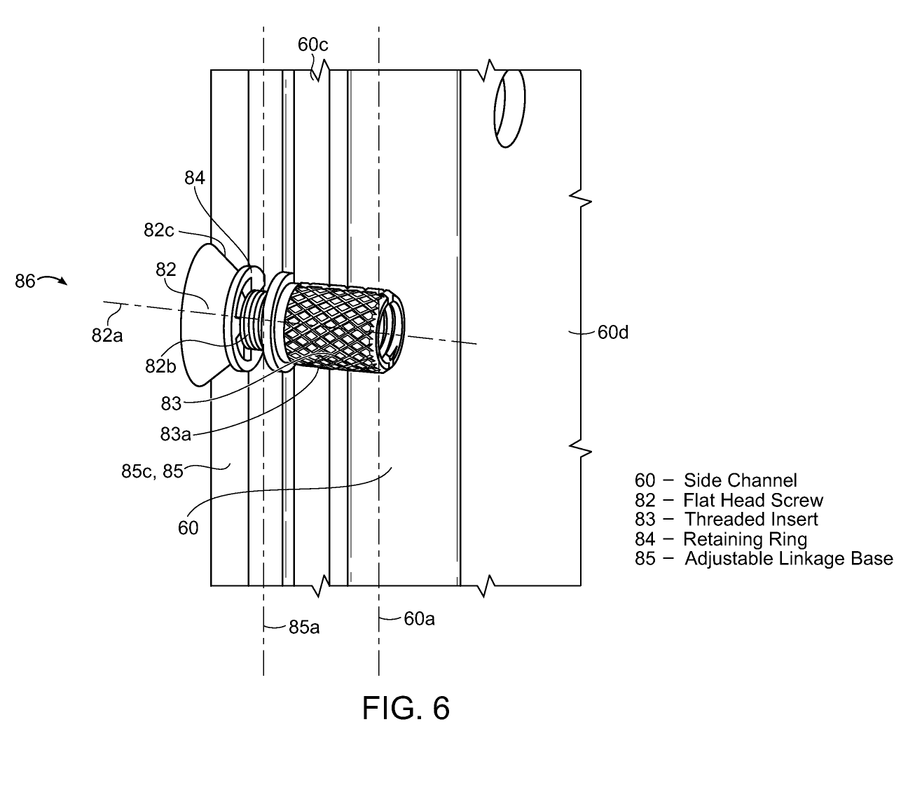

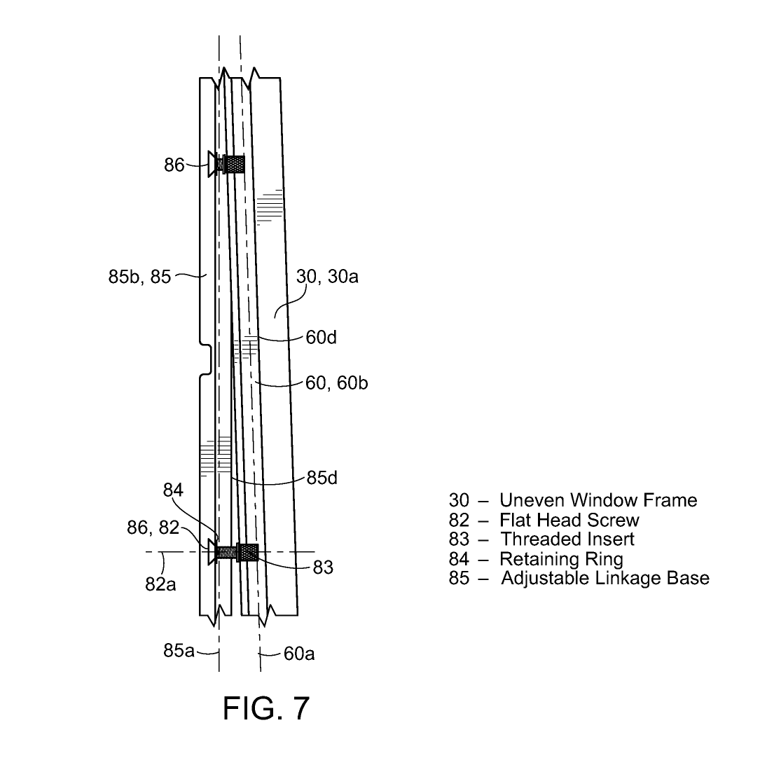

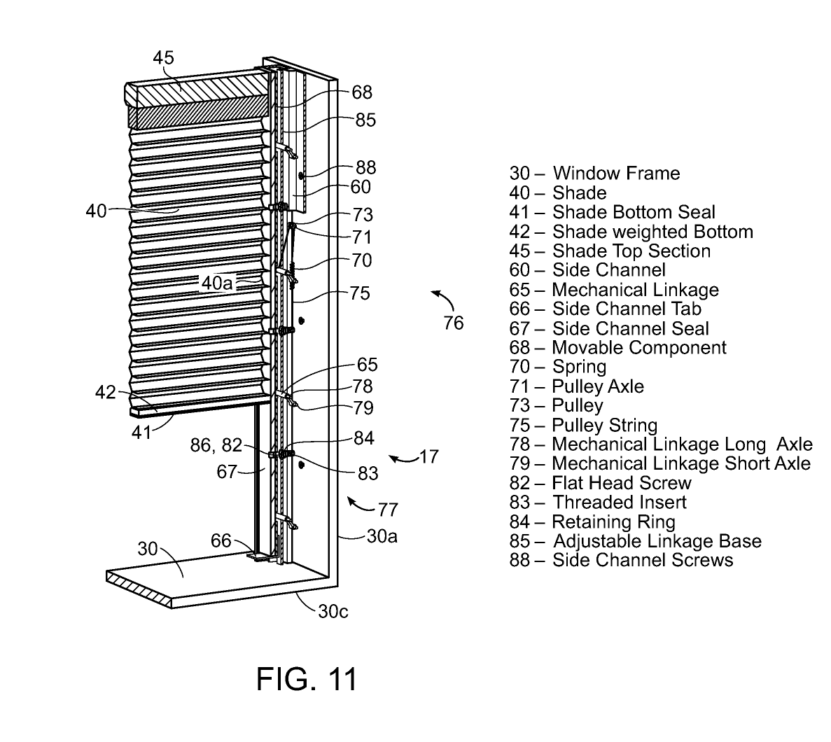

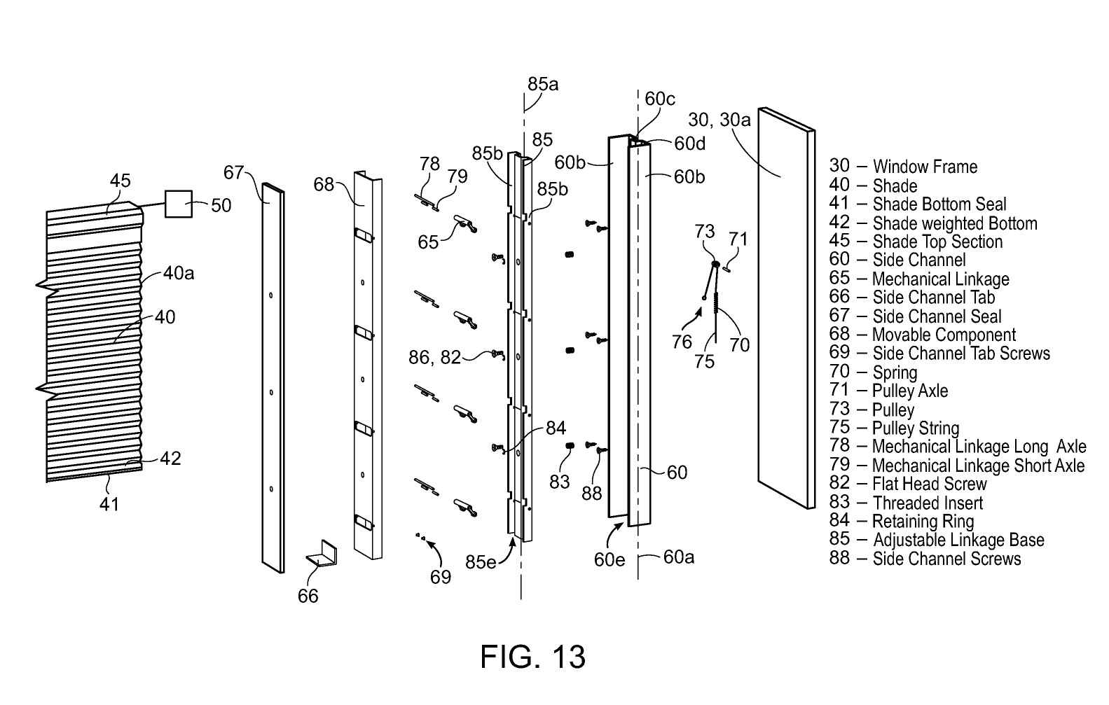

The two side air seals 67 can be movably mounted to opposing or opposite side frame members, which can include upright or vertically oriented elongate side channels or side channel members 60 extending along an upright longitudinal axis 60a. The side channel members 60 can be secured to the two sides window frame members 30a by screws 88 (FIG. 13), and extend between and from the bottom window frame member 30c to the top window frame member 30b. Each side channel member 60 can have two sides or side walls 60b that are connected to each other by a rear wall 60d (FIG. 2). A central elongate ridge 60c can extend from rear wall 60d along axis 60a, protruding into the interior 60e of the side channel member 60. This can form an inward, forward or front facing wider U-shaped channel between sides 60b, and a reverse, outward or rear facing narrower channel formed by central ridge 60c. An elongate adjustable linkage base 85 extending along a longitudinal axis 85a (FIG. 2) can be secured to side channel member 60 within the interior 60e by a series of lateral adjustment mechanisms 86 (FIGS. 6 and 7), for example three (FIGS. 11-13). Each adjustable linkage base 85 can also be generally channel shaped, with two sides or side walls 85b (FIG. 4) connected to each other by a rear wall 85d. An elongate central ridge 85c can extend from rear wall 85d along axis 85a, protruding into the interior 85e of the adjustable linkage base 85. This can form an inward, forward or front facing wider channel between sides 85b, and a reverse, outward or rear facing narrower channel formed by central ridge 85c, which can nest within side channel member 60. The lateral adjustment mechanisms 86 can secure the adjustable linkage base 85 to the side channel member 60 by adjustably securing the central ridges 60c and 85c together at evenly spaced intervals. Central ridge 85c of adjustable linkage base 85 can be wider than the central ridge 60c of side channel member 60, and the sides 85b are narrower than sides 60b, so that the central ridge 85c can nest over central ridge 60c and sides 85b can nest between sides 60b within the interior 60e of side channel member 60. Central ridges 85c and 60c can be shaped in reverse channel configuration with the open side facing in the opposite direction as the openings into the sides 85b and 60b of adjustable linkage base 85 and side channel member 60.

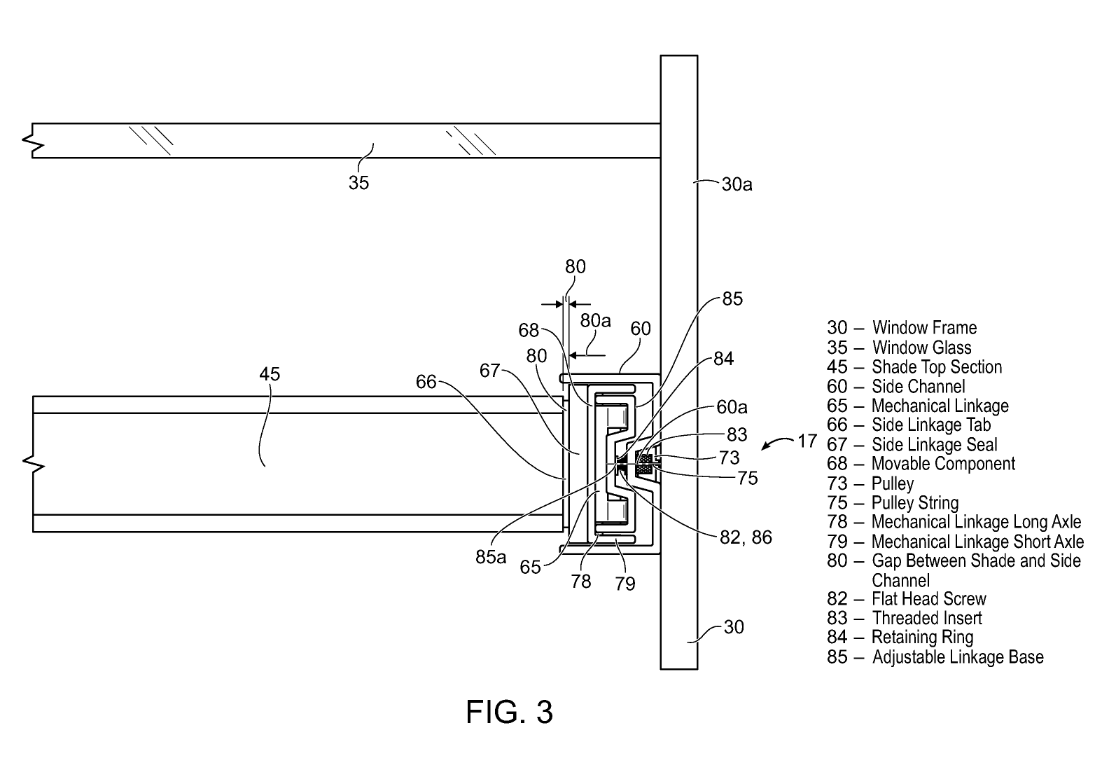

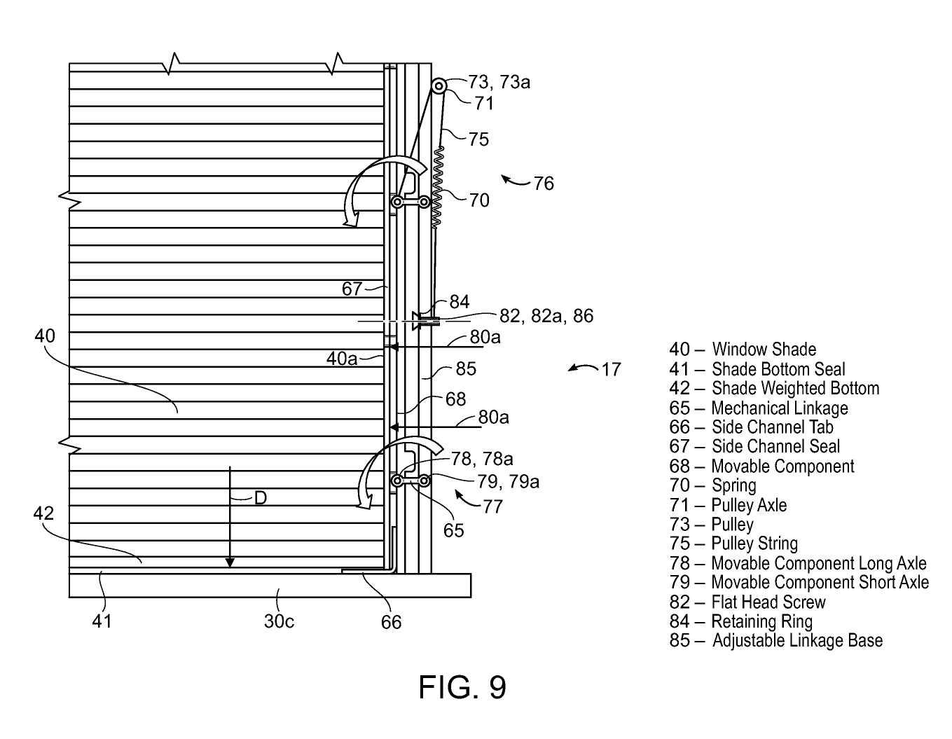

Each side seal member 67 can be secured, attached or mounted to a generally channel shaped movable seal mount component, platen or plate 68, which can be movably, rotatably or pivotably attached to the adjustable linkage base 85 by a series of movable, rotating or pivoting links, link members or mechanical linkages 65 (FIGS. 3, 4 and FIGS. 8-13) such as four, pivotably secured at evenly spaced intervals to adjustable linkage base 85. Each link 65 can have an arm 65a and two legs 65b. Two legs 65b of each link 65 can be pivotably secured by two short axles or pins 79 between sides 85b and central ridge 85c along axis 79a forming pivoting or rotating joints, and the arm 65a can be pivotably secured to the movable seal mount 68 by long axles or pins 78 along axis 78a between sides 68b of movable seal mount 68 forming pivoting or rotating joints. Axes 78a and 79a can be parallel to each other, and generally transverse, orthogonal or perpendicular to axes 60a and 85a. The adjustable linkage base 85, the link 65 and the movable seal mount 68, can form at least one pivoting or rotating four bar linkage 77 which can pivot or rotate the movable seal mount 68 and side seal member 67 from an open or outward retracted position, downwardly and inwardly as shown by the arrows. When in the retracted position, the adjustable linkage base 85, links 65, movable seal mount 68, and side seal member 67 can be generally hidden from view within the side channel member 60. In FIGS. 9 and 12, downward and inward rotation can move the movable seal mount 68 and side seal member 67 in an extended or closed position laterally inwardly as shown by arrow 80 in FIG. 3 to laterally move side seal member 67 across the gap 80 between the side seal member 67 and the lateral side 40a of the shade 40 to engage and seal against the lateral side 40a.

Referring back to FIGS. 3, 4, 6 and 7, if the window opening or window frame 30 is not square or has dimensions that vary from the top to bottom, and/or the side channel member 60 is not square to the shade 40, the series of lateral adjustment mechanisms 86 can be selectively adjusted to adjust the position of one or both adjustable linkage bases 85 relative to a side channel member 60 so that the side seal member 67 can engage the lateral side 40a squarely and evenly for an even consistent surface contact and sealing therebetween along the whole height H of the end or edge surface of the lateral side 40a. Each lateral adjustment mechanism 86 can include a threaded insert 83 mounted within a hole 83a in the central ridge 60c of side channel member 60, and a threaded fastener or adjustment member such as a flathead screw 82 extending through a hole 82c in the central ridge 85c of the adjustable linkage base 85 and threadably engaging the threaded insert 83 along a lateral axis 82a. A spring 82b and a retaining ring 84 can be positioned over or around the screw 82 between the threaded insert 83 and the adjustable linkage base 85 to provide a spring-loaded bias therebetween. Referring to FIG. 7, the lateral adjustment mechanisms 86 can be selectively adjusted to skew or tilt the longitudinal axis 85a of the adjustable linkage base 85 relative to the longitudinal axis 60a of the side channel member 60 to compensate for dimensional variations of an uneven or non-square window frame 30.

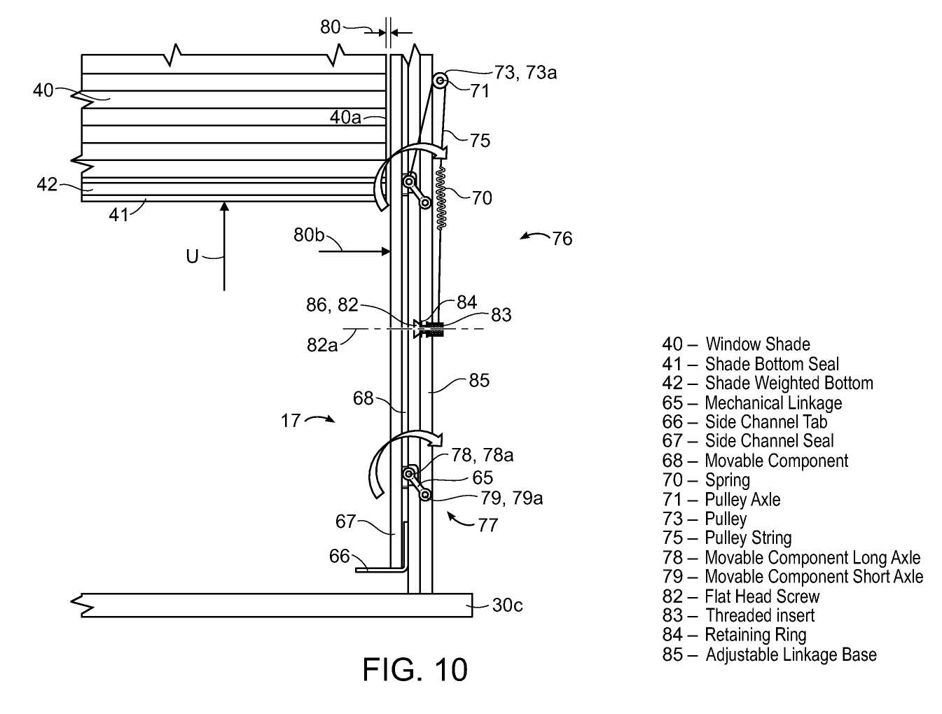

Referring to FIGS. 10 and 11, each movable seal mount 68 and side seal member 67 can be spring biased by a biasing mechanism 76 in the open or retracted position away from the lateral side 40a of the shade 40. A resilient extension member such as a coil extension spring 70 can be secured to each adjustable linkage base 85 and extend upwardly. The pulley line, cable or string 75 can extend upwardly from the spring 70 and around a pulley 73 that rotates around a pulley axle or pin 71 about axis 73a. The pulley line 75 can extend downwardly from the pulley 73 and can be secured to the far end of a selected link 65 at the movable seal mount 68, or to the seal mount 68 itself. This can rotatably or pivotably bias the movable seal mount 68 and side seal member 67 in an upward and outward retracted position where the side seal member 67 is laterally moved away from the lateral side 40a of the shade 40 in the direction of arrow 80b forming a gap 80 therebetween, and the bottom of the side seal member 67 being raised above the bottom frame member 30c of the window frame 30 (FIG. 10). The bottom of each side seal member 67 can have a laterally inwardly extending side channel or seal closure engagement or actuation member or tab 66 which can be engaged by the weighted bottom 42 and bottom seal 41 of the shade 40 when in the down position to pull the movable seal mount 68 and side seal member 67 downwardly and inwardly (FIGS. 9 and 10) against the spring loaded bias of mechanism 76.

In operation, referring to FIGS. 1, 3, 10 and 11, when shade 40 is in the up, open or partially up/open position, the two biasing mechanism 76 can bias the movable seal mounts 68 and the side seal members 67 upwardly and outwardly laterally in the retracted non-sealing position away from the two opposite lateral sides 40a of the shade by a gap 80, and can be recessed within the sides 60b of the side channel members 60. This allows the shade 40 to be moved evenly in the up U and down D directions within the window 10 without any contact or engagement of the side seal members 67 with the lateral sides 40a, so as not to bind, twist, misalign or restrict movement of the shade 40. Referring to FIGS. 2, 4, 5, 9 and 12, when the shade 40 is moved in the down direction D to close the shade 40, the side seal assemblies 17 remain in the open retracted position until the weighted bottom section 42 and the bottom seal 41, or the bottom of shade 40 nears the bottom of the window 10 and engages the two seal engagement or actuation tabs 66 laterally extending from the movable seal mount 68 out of side channel member 60 spaced just above the bottom window frame member 30c. The weight of the bottom of the shade 40 pushes the seal engagement or actuation tabs 66 downwardly with further downward movement D of the shade 40 until reaching the bottom of window 10 where the bottom seal 41 engages and seals against the bottom window frame member 30c and around tabs 66 to prevent airflow therebetween. This pulls the movable seal mounts 68 and side seal members 67 from each side seal assembly 17 downwardly and inwardly towards each other against the bias of springs 70, pivoting or rotating about the pivot axis 79a of links 65 in the direction of the downwardly rotational arrows, thereby moving the two side seal members 67 inwardly laterally in the direction of arrow 80a towards each other to engage against and seal the ends or edges of opposite lateral sides 40a of the shade 40. Referring to FIG. 4, the side seal member 67 can be made of material such as foam soft enough to compress around the edges of the lateral sides 40a of the shade 40 and can be wide enough to indent and wrap around slightly over the front and rear faces of the shade 40. This can provide a seal against the two lateral sides 40a of the shade 40 along the entire height H (FIG. 12) and with W (FIGS. 1A and 1B) to prevent or restrict airflow around the sides 40a or between sides 40a and side seal member 67 or the side window frame members 30a. In some embodiments, other suitable seal materials can be used such as rubber or fibrous compressible materials. In one example, a fabric or backing having long or elongate flexible strands, members or fibers extending in the perpendicular, lateral or horizontal direction can be used. In another example, the seal material can have a scrambled or mixed configuration of fine curly fibers such as in a wool-like or fiber-glass consistency that is compressible. Containing the adjustable linkage bases 85 and movable seal mounts 68 within the side channel members 60 which are in turn, mounted to the side window frame members 30a, and sizing the side channel member 60 to closely surround such components with sides 60b that extend adjacent to the lateral sides 40a of the shade 40, airflow through the side channel members 60 is generally prevented, restricted or limited due to the channel shape. In this manner, the sides and bottoms of the shade 40 can be continuously or completely sealed relative to the bottom and sides of the window 10 so that the shade 40 can provide thermal insulating for the window 10 without air flowing around shade 40 which can compromise the thermal insulating properties of the shade 40, preventing hot air from entering the building from window 10 during the summer, or cold air during the winter, which can provide cost savings in heating and air-conditioning.

Referring to FIG. 10, when the shade 40 is opened or raised in the up direction U, the bottom of the shade 40 is lifted off the engagement or actuation tabs 66, and the springs 70 of biasing mechanisms 76 pull, rotate or pivot the movable seal mounts 68 and side seal members 67 about axes 79a of links 65, upwardly and outwardly away from each other and the lateral sides 40a of the shade 40 in the direction of the rotational arrows. This laterally moves the side seal members 67 outwardly away from each other and the lateral sides 40a in the direction of arrow 80b. This also retracts the movable seal mounts 68 and side seal members 67 back within the side channel members 60, allowing the shade 40 to move upwardly or downwardly without any interference by the side seal members 67. In some embodiments, the shade 40 can be raised and lowered by hand. In other embodiments, the shade 40 can be raised and lowered by at least one motor 50 (can be two), optionally shown in FIG. 13, attached to or within the top shade section 45.

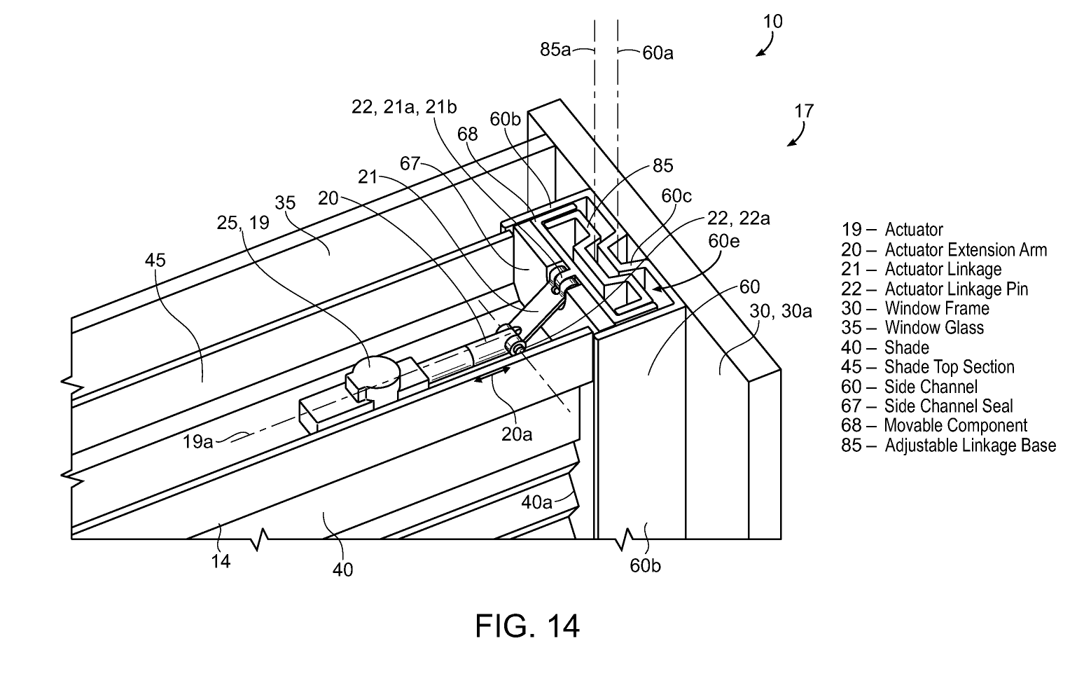

Referring to FIGS. 14-20, another embodiment of a window shade system 14 in the present invention can be installed within a window 10. The window shade system 14 can include two side seal assemblies 17 that differ from those in window shade system 12 in that the biasing mechanism 76 and engagement or actuation tab 66 in each side seal assembly 17 can be replaced with a seal actuator assembly 25 and a sensor or switch, or sensor/switch assembly, arrangement or system 94, for opening and closing the side seal members 67. System 94 can activate the seal actuator assembly 25 when the shade 40 is sensed or directed to be closed, and can also detect if the shade 40 has problems, for example not level or obstructing objects being on the bottom frame member or sill 30c.

Referring to FIGS. 14-16 and 20, each actuator assembly 25 can be mounted on the top shade section 45 inwardly from a corresponding side seal assembly 17. The actuator assembly 25 can include an electrically or electronically controlled actuator 19, for example an electrical solenoid. Actuator 19 can laterally reciprocate an actuator extension arm, rod or member 20 in extended and retracted positions in a telescoping manner as indicated by arrows 20a along a longitudinal axis 19a that is generally transverse, orthogonal or perpendicular to side seal member 67. The distal end of the extension arm 20 can be pivotably connected to a pivoting actuator link or linkage 21 by a pivoting or rotating joint having a linkage pin or axle 22 extending along axis 22a. The actuator link 21 can be pivotably connected to the movable seal mount 68 at or near the top by a pivoting or rotating joint having a linkage pin or axle 22 extending along axis 21a through a protrusion 21b extending from movable seal mount 68.

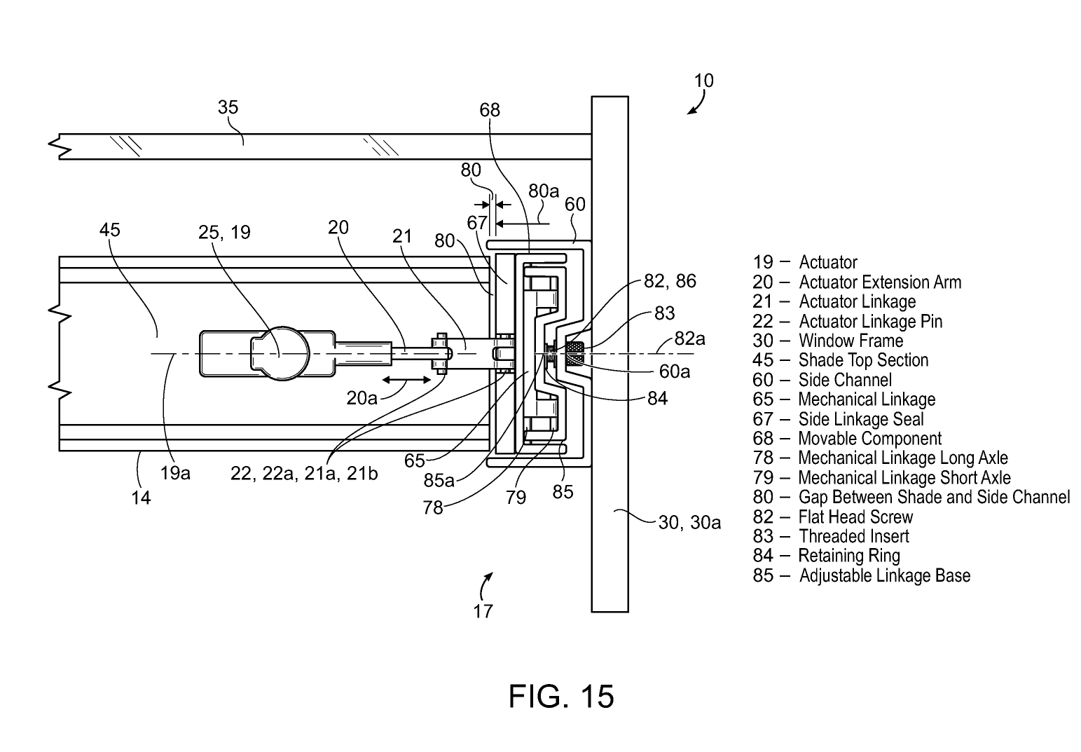

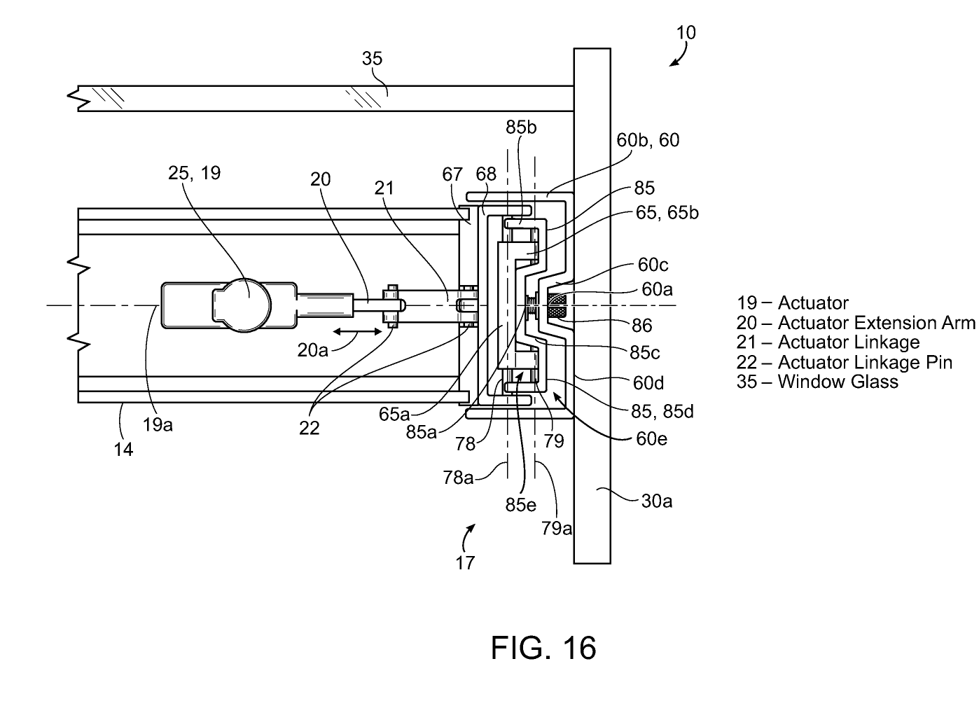

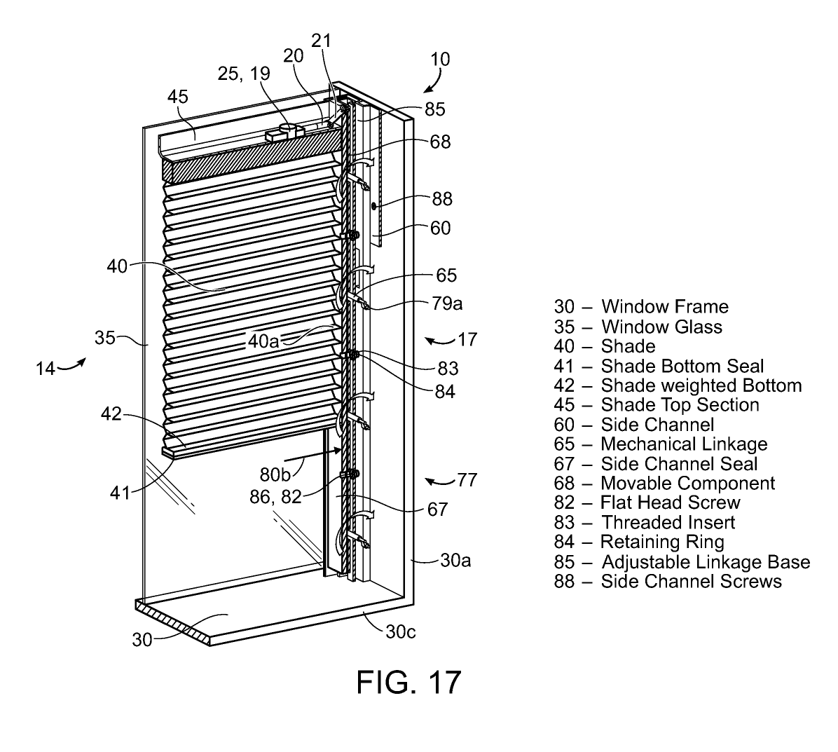

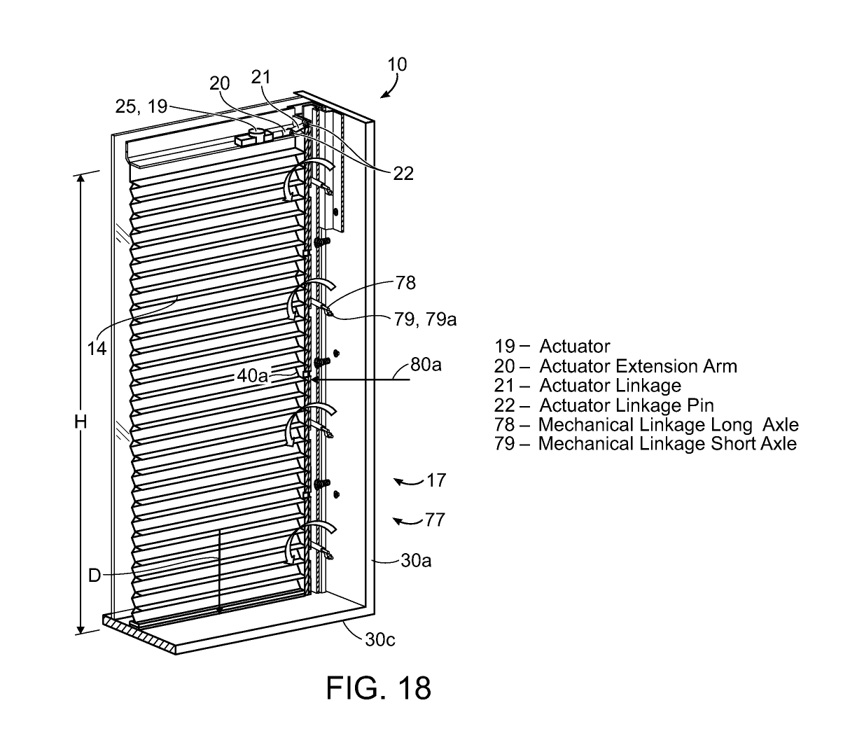

Referring to FIGS. 15 and 16, when an actuator extension arm 20 is in the extended position from actuator 19, the movable seal mount 68 and side seal member 67 is in the rotated upward and outward retracted position within the corresponding side channel member 60, spacing the side seal member 67 apart from the lateral side 40a of the shade 40 by a gap 80. This retracted position allows the shade 40 to be moved up and down without interference, binding or misalignment by the side seal members 67. To engage the side seal members 67 with the lateral sides 40a of the shade 40 when the shade 40 is in the down position, each actuator 19 is actuated to retract the actuator extension arm 20 inwardly in the direction of arrow 20a within the actuator 19. This pulls the movable seal mounts 68 and side seal members 67 towards the corresponding actuator 19 and the lateral side 40a of the shade 40. The pivoting joints of the actuator link 21 allow the actuator extension arm 20 to translate along axis 19a while pulling and rotating or pivoting the movable seal mount 68 and side seal member 67 on each side downwardly and inwardly about axes 79a (FIG. 18) in the direction of the arrows to laterally move the movable seal mount 68 and side seal member 67 laterally inwardly in the direction of arrow 80a closing gap 80 to seal against the lateral sides 40a of shade 40. To raise the shade 40, each actuator 19 can be activated to extend the actuator extension arm 20 in the extended position to retract side seal members 67 away from the shade 40. Extending the actuator extension arm 20 along axis 19a outwardly in the direction of arrow 20a toward side seal member 67 moves the moveable seal mount 68 and the side seal member 67 away from the actuator 19 and the lateral side 40a of the shade 40. The pivoting joints of the actuator link 21 allow the actuator arm to translate along axis 19a while pushing and rotating or pivoting the movable seal mount 68 and side seal member 67 upwardly and outwardly about axes 79a (FIG. 17) in the direction of the arrows to laterally move the movable seal mount 68 and side seal member 67 laterally outwardly in a direction of arrow 80b opening gap 80. With the side seal members 67 being in the retracted position, shade 40 can be raised.

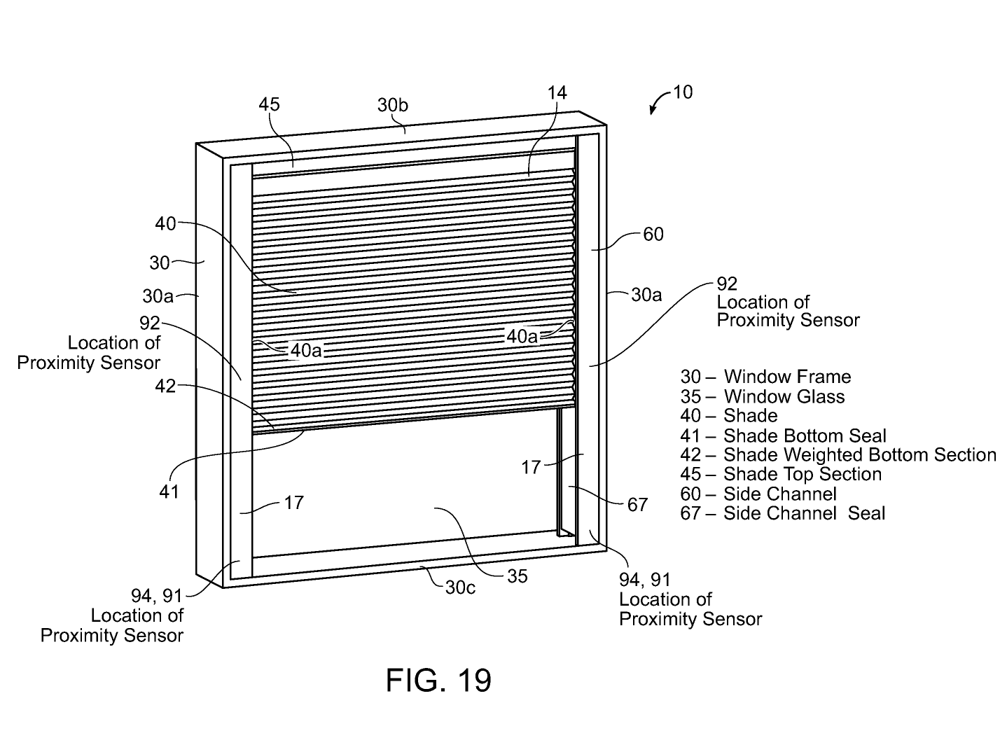

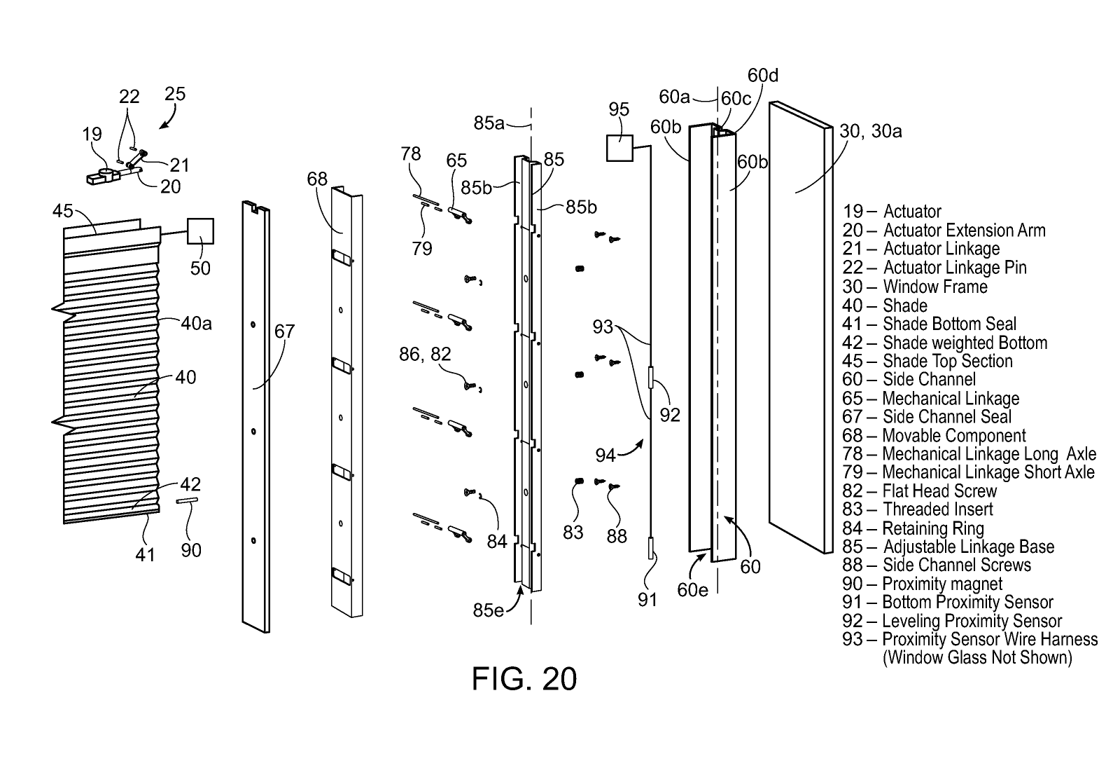

Referring to FIGS. 19 and 20, in one embodiment, each sensor, switch or sensor/switch system 94 can include a switch or sensor component such as a proximity magnet 90 on or within a side of the bottom of shade 40. A bottom switch or sensor such as a proximity sensor 91 can be located within the bottom of the corresponding side channel member 60 and a leveling switch or sensor such as a proximity sensor 92 can be located midway within the side channel member 60, and which can be electrically connected to each other and a controller 95 by lines or a wire harness 93. The controller 95 can be connected to the two actuators 19 for control thereof, and can be connected to at least one motor 50. Each actuator 19 can move and close or engage the side seal member 67 against the shade 40 when the switch 91 is activated when the bottom of the shade 40 reaches and engages the bottom window frame member 30c, and proximity magnet 90 is sensed by switch 91. Alternatively, the actuator 19 can move and open and retract the side seal member 67 away from the shade 40 when the bottom of the shade 40 is lifted from the bottom window frame member 30c and/or is commanded by controller 95 to open so that the shade 40 can be raised, for example by a user pressing an up button. Two proximity sensors 92 together with controller 95 can determine if the shade 40 is level or travelling at the same speed at both sides, or if no obstructions are on the bottom frame member or sill 30c, and if not, the shade 40 can be pulled back up into a retracted position and an alarm sent out, or can be stopped in place. In another embodiment, two leveling proximity sensors 92 can work in conjunction with each other via controller 95 to adjust the at least one motor 50 to keep shade 40 level. In some embodiments, only one sensor, switch, or sensor/switch system 94 can be used for operating two actuators 19 for opening and closing both side seal assemblies 17 and/or can also include mechanical, manual or limit switches. In some embodiments, actuator 19 can be other suitable linear actuators, such as motor driven lead screws, or can be a rotary actuator for rotating a link 65 about its axis 79a. The shade 40 can be manually raised or lowered, or by at least one motor 50.

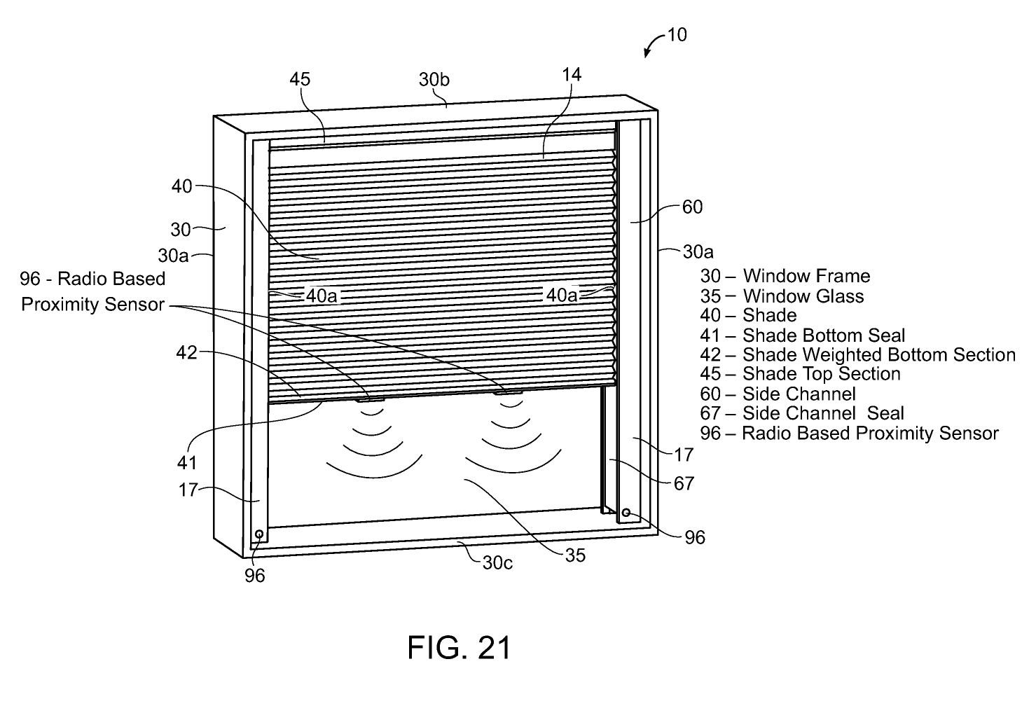

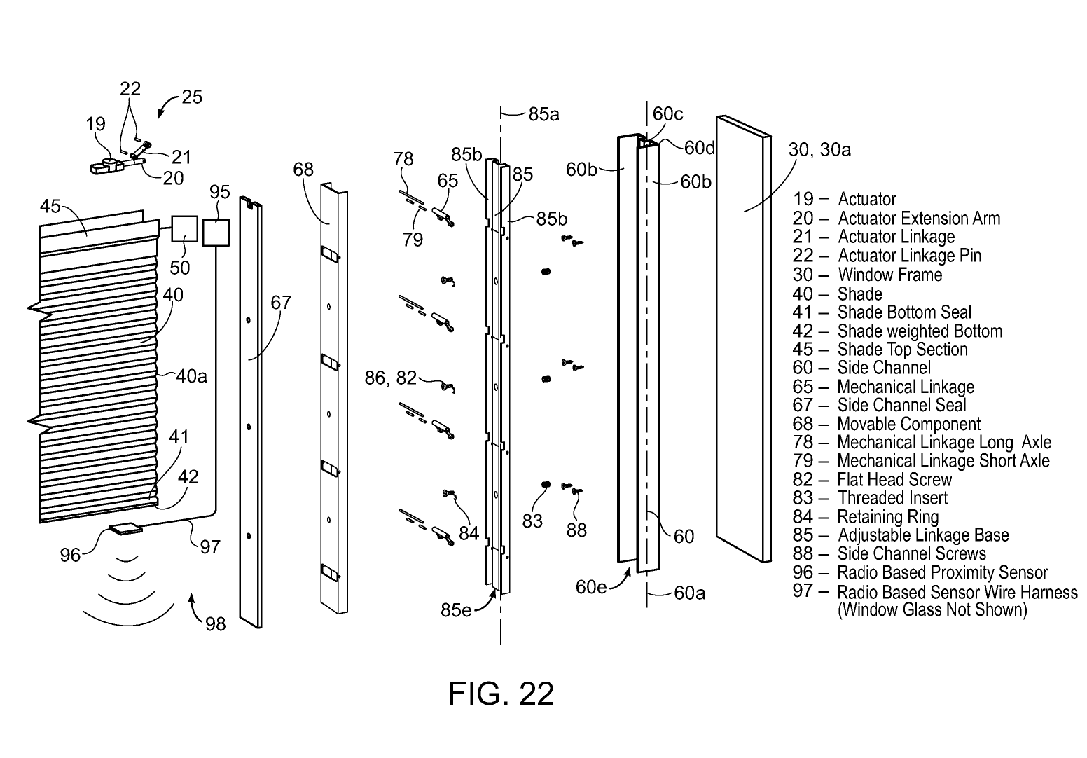

Referring to FIGS. 21 and 22, in another embodiment, sensor, switch, or sensor/switch system 94 can be replaced by switch, sensor, or sensor/switch assembly, arrangement or system 98, which differs from system 94 in that system 98 can include a radio-based proximity sensor 96 positioned at each side of the bottom of shade 40, and electrically connected by a line or wire harness 97 to controller 95. System 98 can close side seal assemblies 17 when sensor 96 senses the shade 40 is in the down position, and open side seal assembly 17 when shade 40 is sensed to be raised and/or commanded to open by controller 95, as previously described. Sensors 96 can have distance and leveling sensing capabilities and can be used to detect interference or obstructions by objects on the bottom frame member or sill 30c, or if the bottom of the shade 40 is not level. In some embodiments, sensors 96 can be placed additionally or alternatively at or within the bottom of the side channel members 60 and face or look upwards. In various embodiments, systems 94 and 98 can use other suitable sensors or switches, such as laser, optical, IR, sensors/switches, etc.

While this invention has been particularly shown and described with references to example embodiments thereof, it will be understood by those skilled in the art that various changes in form and details may be made therein without departing from the scope of the invention encompassed by the appended claims.

Although various directional designations such as upper, top, bottom, lower, sides, inwardly, outwardly etc., have been described for embodiments, it is understood that the shade 40 and sealing assemblies can be positioned in other orientations. Various features described for the embodiments can be combined together or omitted. In some embodiments, linkage base 85 can be mounted to side window frame member 30a, and in other embodiments, the links 65 can be rotatably mounted to the side window frame members 30a, wherein the side window frame members 30a can be considered a side frame member of the sealing apparatus. Suitable materials for the side channel members 60 and components of the side seal assemblies 17 can include metals such as steel and aluminum, plastics, composite materials and wood products.

What is claimed is:

1. A sealing apparatus for a window shade that is vertically raised and lowered, comprising: a first side seal assembly having a first side seal member that is vertically oriented, the first side seal member being movably connected to a first side frame member by a first movable arrangement for moving the first side seal member into and out of sealing position relative to a first side of the window shade.

2. The apparatus of claim 1 in which the first movable arrangement comprises a linkage for moving the first side seal member into and out of sealing position relative to the first side of the window shade.

3. The apparatus of claim 2 in which the linkage is biased by a spring in a non-sealing direction.

4. The apparatus of claim 3 further comprising a first side seal activation tab extending laterally from a bottom of the first side seal member for being engaged by a bottom of the window shade when lowered for pulling the first side seal member downwardly and laterally against the first side of the window shade.

5. The apparatus of claim 2 in which the linkage, the first side seal member and the first side frame member form at least one four bar linkage.

6. The apparatus of claim 5 in which the first side frame member comprises a vertically oriented channel member for securing to a window frame, a vertically oriented adjustable linkage base being secured within the channel member, the first side seal member being movably connected to the adjustable linkage base by the linkage.

7. The apparatus of claim 6 further comprising at least one lateral adjustment mechanism between the channel member and the adjustable linkage base for adjusting to compensate for non-square window frames.

8. The apparatus of claim 1 further comprising a second side seal assembly having a second side seal member that is vertically oriented, the second side seal member being movably connected to a second side frame member by a second movable arrangement for moving the second side seal member into and out of sealing position relative to a second side of the window shade.

9. The apparatus of claim 8 further comprising the window shade, thereby forming a window shade system with movable side seals, the first and second side seal members being normally in a non-sealing position to allow the window shade to be vertically raised and lowered without interference by the side seal members, the first and second side seal members being activated to move by the respective movable arrangements into sealing position to seal relative to the first and second sides of the window shade when the window shade is in the lowered position.

10. The apparatus of claim 1 in which the first movable arrangement moves the first side seal member in a lateral direction into and out of sealing position relative to a side edge of the first side of the window shade.

11. The apparatus of claim 10 in which the first movable arrangement includes an electronically controlled actuator.

12. The apparatus of claim 11 in which the first movable arrangement comprises a linkage actuated by the actuator for moving the first side seal member into and out of sealing position.

13. The apparatus of claim 12 in which the actuator includes a telescoping extension arm connected to the linkage by a pivoting actuator link, the actuator being positioned laterally relative to the first side seal member and above the window shade.

14. The apparatus of claim 11 in which the electronically controlled actuator is controllable with at least one of sensors and switches.

15. A sealing apparatus for a window shade that is vertically raised and lowered, comprising: a first side seal assembly having a first side seal member that is vertically oriented, the first side seal member being movably connected to a first side frame member by a first movable arrangement for moving the first side seal member into and out of sealing position relative to a side edge of a first side of the window shade; and
a second side seal assembly having a second side seal member that is vertically oriented, the second side seal member being movably connected to a second side frame member by a second movable arrangement for moving the second side seal member into and out of sealing position relative to a side edge of a second side of the window shade, whereby the first and second side seal members move towards each other when moving into sealing position, and away from each other when moving out of sealing position.

16. A method of releasably sealing a window shade that is vertically raisable and lowerable with a vertically oriented first side seal member of a first side seal assembly comprising:
with the first side seal member being out of sealing position, vertically lowering the window shade downwardly until reaching a lowered position;
activating a first movable arrangement when the window shade is near or at the lowered position to move the first side seal member into sealing position relative to a first side of the window shade for sealing therebetween, the first side seal member being movably connected to a first side frame member by the first movable arrangement; and
vertically raising the window shade and activating the first movable arrangement to move the first side seal member out of sealing position relative to the first side of the window shade so as not to interfere with the raising of the window shade.

17. The method of claim 16 in which the first movable arrangement comprises a linkage, the method further comprising moving the first side seal member into and out of sealing position relative to the first side of the window shade with the linkage.

18. The method of claim 17 further comprising biasing the linkage in a non-sealing direction with a spring.

19. The method of claim 18 in which a first side seal activation tab extends laterally from a bottom of the first side seal member, the method further comprising engaging said tab with a bottom of the window shade when lowered for pulling the first side seal member downwardly and laterally against the first side of the window shade.

20. The method of claim 17 in which the linkage, the first side seal member and the first side frame member form at least one four bar linkage.

21. The method of claim 20 in which the first side frame member comprises a vertically oriented channel member for securing to window frame, a vertically oriented adjustable linkage base being secured within the channel member, the method further comprising moving the first side seal member relative to the adjustable linkage base with the linkage that is movably connected therebetween.

22. The method of claim 21 further comprising adjusting at least one lateral adjustment mechanism between the channel member and the adjustable linkage base to compensate for non-square window frames.

23. The method of claim 16 further comprising a second side seal assembly having a second side seal member that is vertically oriented, the method further comprising moving the second side seal member into and out of sealing position relative to a second side of the window shade with a second movable arrangement.

24. The method of claim 23 further comprising normally positioning the first and second side seal members in a non-sealing position to allow the window shade to be raised and lowered without interference by the side seal members and activating the first and second side seal members to move by the respective movable arrangements into sealing position to seal relative to the first and second sides of the window shade when the window shade is in the lowered position.

25. The method of claim 16 further comprising moving the first side seal member in a lateral direction into and out of sealing position relative to a side edge of the first side of the window shade.

26. The method of claim 25 in which the first movable arrangement includes an electronically controlled actuator.

27. The method of claim 26 in which the first movable arrangement comprises a linkage actuated by the actuator for moving the first side seal member into and out of sealing position.

28. The method of claim 27 in which the actuator includes a telescoping extension arm connected to the linkage by a pivoting actuator link, the actuator being positioned laterally relative to the first side seal member and above the window shade.

29. The method of claim 26 further comprising controlling the electronically controlled actuator with at least one of sensors and switches.
